(19) United States
(12) Patent Application Publication
(10) Pub. No.: US 2015/0109909 A1
(43) Pub. Date: Apr. 23, 2015

(54) USER-BASED PROFILING AND NETWORK ACCESS

(71) Applicant: Time Warner Cable Enterprises LLC, New York, NY (US)

(72) Inventors: Kiran R. Yeddala, Ashburn, VA (US); Don Gunasekara, Reston, VA (US)

(21) Appl. No.: 14/059,137

(22) Filed: Oct. 21, 2013

(51) Int. Cl. H04W 48/04; H04W 72/04; H04W 28/02

(52) U.S. Cl. CPC H04W 48/04; H04W 28/0215; H04W 72/044; H04W 88/08
USPC 370/230; 370/328

(57) ABSTRACT

A subscriber domain in a cable network environment can include an access manager. During operation, the access manager receives input indicating an identity of a user operating a communication device to access a remote network such as the Internet. The user may be one of multiple possible users that use the communication device to access the remote network. To provide access, the access manager maps the received identity of the user to corresponding access profile information assigned to the user. In accordance with the corresponding access profile information assigned to the user, the access manager provides the communication device access to the remote network. Accordingly, in contrast to conventional techniques, each of multiple different users can be afforded different network access rights even though they happen to use the same computer device to access a respective network.

### BACKGROUND

In general, conventional techniques have been used to provide network access to computers in a home network environment. For example, a home network environment can include an access resource such as a cable modem, WiFi™ access point, etc. The access resource is typically coupled to a respective network such as the Internet via a respective communication link such as a coaxial cable or fiber. Via communications through the access resource and communication link, a respective communication device is able to retrieve content from the Internet or other network resource.

In certain instances, a conventional access resource supports access to a respective network on a per-device basis. For example, each computer device used in a home network environment is typically assigned a unique device identifier value such as a MAC-ID (Media Access Control—Identifier) and/or Host-Name. Certain conventional home wireless network equipment vendors support the ability to restrict network access by a device based on the assigned MAC-ID/Host-Name/IP Address. For example, a particular computer device can be provided different levels of access to a network depending on an assigned network address.

According to conventional techniques, once restriction settings are assigned to a given computer access device, each user that uses the given computer device to retrieve data through the access resource is restricted in a same manner. That is, the access resource applies access restrictions on a per-device basis (in accordance with an assigned network address) regardless of a user that uses the computer device to access content.

### BRIEF DESCRIPTION OF EMBODIMENTS

Conventional techniques suffer from deficiencies. For example, as discussed above, restrictive access settings are assigned to a given computer access device. Each user that uses the given computer device is restricted in a same manner because restrictions are applied on a per-device basis.

Additionally, there is currently no way to control bandwidth usage amongst multiple users in a subscriber domain of a cable network environment. For example, in certain instances, a subscriber domain may be allocated upstream and downstream bandwidth for use by a collective set of members in the subscriber domain. Multiple communication devices (such as computers) can be simultaneously connected to an access point to retrieve content from a remote network. In certain cases, greedy algorithms executing in the communication devices typically compete amongst each other for use of the available bandwidth to retrieve data, resulting in inefficient and potentially unfair use of available bandwidth allocated for use by the subscriber domain.

Embodiments herein deviate with respect to conventional techniques. For example, embodiments herein provide different levels of network access depending on a respective access profile assigned to a user operating the computer device. As discussed herein, the access profiles are used to implement features such as webpage filtering, application/protocol filtering, local/remote media access, etc. Additionally, embodiments herein enable a subscriber in a respective subscriber domain to control usage of available bandwidth via respective access profiles assigned to different users.

More specific embodiments include an access manager such as an access point providing access to multiple users. The access point can be a wireless access point. During operation, the access manager receives input indicating an identity of a user operating a respective communication device (such as a computer device). The user operates the communication device to communicate with the access manager and access a remote network.

In certain instances, the user may be one of multiple possible users in a subscriber domain that use the communication device to access the remote network. In one embodiment, to provide network access, the access manager maps a received identity of the user (currently using the communication device) to corresponding access profile information assigned to the user. In accordance with the corresponding access profile information assigned to the user, the access manager provides the communication device access to the remote network.

Accordingly, in contrast to conventional techniques, each of multiple different users can be afforded different network access rights even though they happen to use the same computer device to access a respective network. In other words, one embodiment herein include granting different levels of network access rights on a per-user basis as opposed to granting access on a per-computer basis.

As previously discussed, the access manager can be configured to map the identity of a user currently operating the communication device to corresponding access profile information. In one embodiment, to achieve this end, the access manager accesses a map. The map can include multiple entries, each of which maps a respective unique user identity to respective access profile information. During the mapping process, the access manager identifies an entry amongst the multiple entries that is associated with the identity of a current computer user as specified by received input. The access manager selects the corresponding profile information associated with the identified entry to control network access associated with the user.

In accordance with yet further embodiments, at or around a time of receiving a request to access a remote network such as through shared communication link of cable network environment, the access manager can receive a network address of the communication device used by the user to access the remote network. In order to provide network access, the access manager associates the corresponding access profile information (assigned to the user) with the network address to the to keep track of the access privileges to be granted to the corresponding communication device. The access manager then controls data traffic flows to and from the communication device in a manner as specified by the corresponding access profile information assigned to the user.

The access manager can reside in a subscriber domain of a cable network environment. The subscriber domain may be one of multiple subscriber domains in a service group of the cable network environment that share a respective communication link to access different content available from the remote network. Each subscriber domain can be allocated an amount of bandwidth to communicate on the shared communication link.

The access manager can be communicatively coupled to the remote network such as the Internet via a shared communication link. Other subscriber domains can be configured to use the shared communication link to access the remote network. Each of the subscriber domains can be allocated a limited bandwidth of the shared communication link to retrieve and transmit data. The limited bandwidth can be a guaranteed bandwidth to be provided to the subscriber. Allocation of bandwidth can depend on various network factors, especially since the shared communication link can be a Wi-Fi network, cable network, etc. The bandwidth can be the maximum available to the user.

The limited bandwidth available to a subscriber domain can be shared fairly amongst the different users in the subscriber domain in accordance with the assigned access profile information associated with users in a respective subscriber domain. For example, in a given subscriber domain, the corresponding access manager can be configured to apportion use of the limited available bandwidth in the shared communication link amongst the multiple users in a manner as indicated by assigned access profile information.

Further embodiments herein include providing an administrator (such as a parent, subscriber account holder, etc.) in a respective subscriber domain the ability to create different access profiles for members in a given subscriber domain. For example, the administrator in the given subscriber domain can communicate with or execute an access profile manager application. Via the access profile manager application, the administrator (such as a subscriber) can create a first access profile for a first member in the given subscriber domain; the administrator can create a second access profile for a second member in the given subscriber domain; the administrator can create a third access profile for a third member in the given subscriber domain; and so on.

During creation of access profiles, from the administrator, the access profile manager application receives settings associated with the first access profile, second access profile, third access profile, and so on. The access profile manager application stores the settings associated with the first access profile, second access profile, etc., in a repository. If desired, the administrator can communicate with the access profile manager application to modify the first access profile information, the second access profile information, third access profile information, and so on.

As mentioned, the access manager uses the access profiles created by the administrator to control network access in a subscriber domain.

These and other more specific embodiments are disclosed in more detail below.

Note that any of the resources as discussed herein can include one or more computerized devices, servers, base stations, wireless communication equipment, communication management systems, workstations, handheld or laptop computers, or the like to carry out and/or support any or all of the method operations disclosed herein. In other words, one or more computerized devices or processors can be programmed and/or configured to operate as explained herein to carry out different embodiments of the invention.

Yet other embodiments herein include software programs to perform the operations summarized above and disclosed in detail below. One such embodiment comprises a computer program product including a non-transitory computer-readable storage medium (i.e., any physical computer readable hardware storage medium) on which software instructions are encoded for subsequent execution. The instructions, when executed in a computerized device having a processor, program and/or cause the processor to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, etc., or other a medium such as firmware or shortcode in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One or more embodiment includes a computer readable storage medium and/or system having instructions stored thereon. The instructions, when executed by computer processor hardware, cause the computer processor hardware of the system to: receive input indicating an identity of a user operating a communication device; map the identity of the user to corresponding access profile information assigned to the user; and provide the communication device access to a remote network as specified by the corresponding access profile information assigned to the user.

Yet another embodiment herein includes a computer readable storage medium and/or system having instructions stored thereon. The instructions, when executed by computer processor hardware, cause the computer processor hardware to: at an access point, receive requests for content from each of multiple communication devices in a first network; initiate retrieval of the requested content from a remote network; and control flows of the requested content downstream from the access point to the multiple communication devices in accordance with access profiles assigned to users operating the communication devices.

Note that the ordering of the operations can vary. For example, any of the processing operations as discussed herein can be performed in any suitable order.

Other embodiments of the present disclosure include software programs and/or respective hardware to perform any of the method embodiment operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor, or within an operating system or a within a software application.

As discussed herein, techniques herein are well suited for providing different levels of network access to users in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

FIG. 1 is an example diagram illustrating network access management in a network environment according to embodiments herein.

FIG. 2 is an example diagram illustrating access management on a per-user basis according to embodiments herein

FIG. 3 is an example diagram illustrating generation and storage of access profiles according to embodiments herein.

FIG. 4 is an example diagram illustrating a mapping of users to corresponding access profiles according to embodiments herein.

FIG. 5 is an example diagram illustrating first access/flow control settings according to embodiments herein.

FIG. 6 is an example diagram illustrating second access/flow control settings according to embodiments herein.

FIG. 7 is an example diagram illustrating communications facilitating network access management using one or more access profiles according to embodiments herein.

FIG. 8 is an example diagram illustrating a user interface to manage access profile information according to embodiments herein.

FIG. 9 is an example diagram illustrating a user interface to view access settings and network usage information according to embodiments herein.

FIG. 10 is an example diagram illustrating a user interface to view network usage amongst multiple users according to embodiments herein.

FIG. 11 is a diagram illustrating an example computer architecture in which to execute any of the functionality according to embodiments herein.

FIG. 12 is an example diagram illustrating a method of controlling network access according to embodiments herein.

FIG. 13 is an example diagram illustrating a method of controlling network access according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION AND FURTHER SUMMARY OF EMBODIMENTS

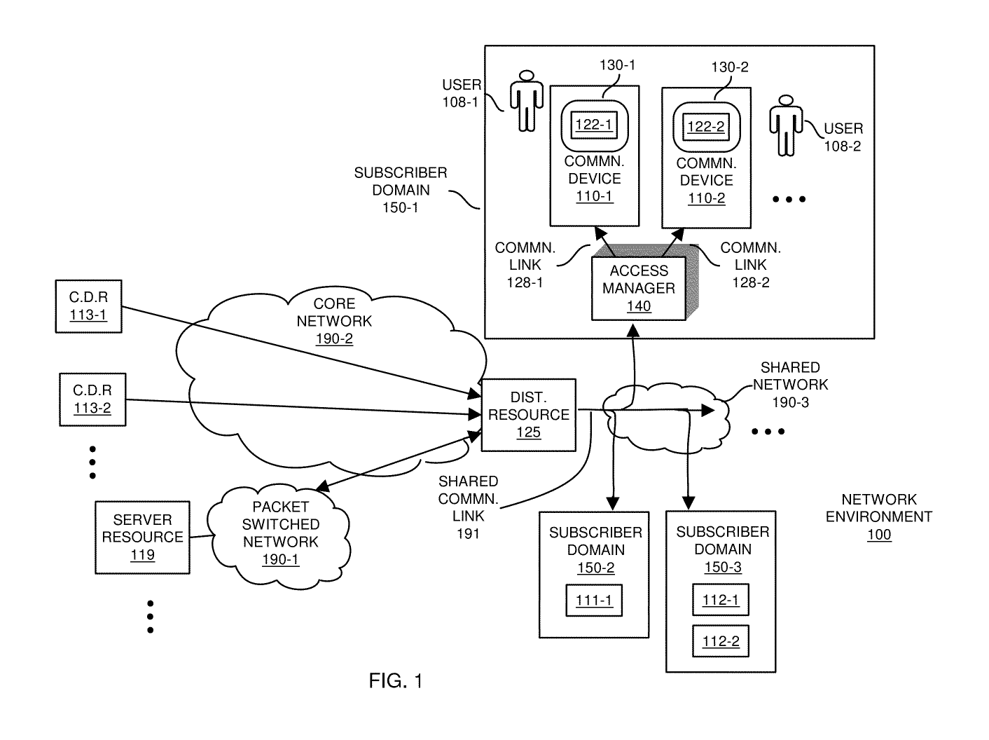

Now, more specifically, FIG. 1 is an example diagram illustrating a network environment according to embodiments herein.

As shown, network environment 100 includes multiple networks 190. Network environment 100 can include a packet-switched network 190-1, a core network 190-2, shared network 190-3, etc.

In general, via the different types of networks 190, respective subscribers and corresponding playback devices (such as communication devices 110, 111, 112, . . . ) in subscriber domains 150 are able to retrieve and playback different types of content such as over-the-top content, scheduled broadcast content, video on-demand content, etc.

More specifically, each subscriber domain in network environment 100 can include one or more playback devices to retrieve and play back content.

In this example embodiment, communication device 110-1 includes display screen 130-1 and plays back a rendition of selected content 122-1; communication device 110-2 includes display screen 130-2 and plays back a rendition of selected content 122-2; and so on.

Subscriber domain 150-2 includes communication device 111-1.

Subscriber domain 150-3 includes communication device 112-1 and communication device 112-2.

In addition to one or more playback devices (such as communication device 110-1, communication device 110-2, etc.), each subscriber domain can also include an access manager 140 that manages access to shared communication link 191. In this example embodiment, subscriber domain 150-1 includes access manager 140 to control access to packet-switched network 190-1 and core network 190-2.

Access manager 140 can be any suitable type of resource such as a set-top box, cable modem, WiFi™ network, access point, server resources, data router, etc.

Communication links 128 between the access manager 140 and respective communication devices 110 can be any suitable type of communication medium such as a physical medium, a wireless medium, etc. As mentioned, in one embodiment, the access manager 140 is an access point controlling network access for each of multiple members in subscriber domain 150-1.

By way of a non-limiting example, access manager 140 can be a wireless access point; communication links 128 can be wireless links between the access manager 140 and the communication devices 110. For example, communication link 128-1 can be a wireless communication link supporting communications between access manager 140 and communication device 110-1; communication link 128-2 can be a wireless communication link supporting communications between access manager 140 and communication device 110-2; and so on.

By way of a non-limiting example, the access manager 140 can communicate with the communication devices 110 via any suitable protocol or WiFi™ standards such as IEEE (Institute of Electrical and Electronics Engineers) 802.11a, 802.11b, 802.11g, 802.11n, etc.

In one embodiment, access manager 140 facilitates distribution of content received over shared communication link 191 to the devices 110. For example, via communications through the access manager 140 and over shared communication link 191 to distribution resource 125 (such as a cable modem termination system), the communication devices 110 in subscriber domain 150-1 can initiate retrieval of content such as video on demand content, over-the-top content, broadcast content, IPTV content, etc.

Access manager 140 can receive broadcast content (from content delivery resource 113-1, content delivery resource 113-2, etc.) transmitted over predetermined channels in shared network 190-3 to multiple subscriber domains 150. To play back broadcast content, the access manager 140 can be configured to tune to one or more channels as indicated by users of communication devices 110-1.

In one embodiment, in addition to conveying broadcast content, the shared communication link 191 can be configured to support distribution of so-called over-the-top content. For example, a portion of bandwidth in shared communication link 191 can be allocated to support data channels in accordance with DOCSIS (Data Over Cable Service Interface Specification) or any other suitable communication standard. Each subscriber domain can be assigned use of a portion of bandwidth in the data channels to communicate data upstream or downstream. Via the data channels, each of the subscribers in respective subscriber domains 150 can retrieve over-the-top content from respective server sources disposed in packet-switched network 190-1 such as the Internet. As its name suggests, packet-switched network 190-1 enables routing of data packets based on network address information.

By way of a further non-limiting example, packet-switched network 190-1 can support client-server type communications. For example, a communication device 110-1 operated by a respective user 108-1 can generate a request for retrieval of content from a particular server resource such as server resource 119 using an appropriate network address of the server resource 119. Assuming that the communication device 110 has already established a respective communication link 128-1 with access manager 140, the communication device 110-1 transmits the request to access manager 140. On behalf of the communication device 110-1, the access manager 140 transmits the request for content over shared communication link 191 and packet-switched network 190-1 to server resource 119.

In response to receiving the request for content, the server resource 119 transmits the requested content over packet-switched network 190-1 (as over-the-top content) and shared communication link 191 to the access manager 140. The access manager 140 forwards the received content to communication device 110-1 in subscriber domain 150-1 using the network address of the communication device 110-1. In this manner, each of the communication devices in subscriber domain 150 can retrieve content via communication through the access manager 140.

In one embodiment, core network 190-2 is or includes a cable network supporting services such as distribution of content via one or more cable television channels (e.g., QAM or quadrature amplitude modulated channels, IPTV channels, etc.) to subscriber domains in network environment 100.

As shown, shared network 190-3 (including shared communication link 191) supports final connectivity to subscribers or subscriber domains 150 and may include physical media such as one or more coaxial cables, optical fibers, twisted wire pairs, etc., to provide connectivity between distribution resource 125 and the subscriber domains 150.

In one embodiment, each subscriber domain connected to the shared communication link 191 in shared network 190-3 is part of a respective service group that receives a same set of downstream signals transmitted by distribution resource 125. Any of the devices in the service group can tune to the streaming content broadcasted over shared communication link 191. Other content transmitted over the shared communication link 191 may be specifically addressed to the access manager 140 residing in a respective subscriber domain. As mentioned, the access manager 140 forwards received content to appropriate one or more communication devices in a respective subscriber domain.

During operation, the access manager 140 can receive input indicating an identity of a user operating a respective communication device. For example, user 108-1 operates communication device 110-1; user 108-2 operates communication device 110-2.

In this example embodiment, assume that each of the users 108 operates the communication devices to access a remote network such as packet-switched network 190-1, core network 190-2, etc. User 108-1 is one of multiple possible users that potentially use the communication device 110-1 to access the remote network 190-2.

In one embodiment, to provide the user 108-1 access to content available from network 190-2, the access manager 140 maps the received identity of the user (currently using the communication device 110-1) to corresponding access profile information assigned to the user 108-1. In accordance with the corresponding access profile information assigned to the user 108-1, the access manager 140 provides the communication device 110-1 access to the packet-switched network 190-1 or core network 190-2.

Accordingly, in contrast to conventional techniques, each of multiple different users 108 can be afforded different network access rights even though they happen to use the same computer device (communication device) to access a respective network. In other words, one embodiment herein include granting network access rights on a per-user basis as opposed to granting network access rights on a per-computer basis.

As a further non-limiting example embodiment, the access manager 140 can be an access point disposed in subscriber domain 150-1. The access manager 140 receives requests for content from each of multiple communication devices 110. For example, user 108-1 can execute a browser, media player application, etc., on communication device 110-1. Assume that the user 108-1 transmits a request to access manager 140 for retrieval of first content available in packet-switched network 190-1. In such an instance, the access manager 140 keeps track of the network address of communication device 110-1. On behalf of the communication device 110-1, the access manager 140 transmits the request for first content upstream over shared communication link 191 to an appropriate server (such as server resource 119) in packet-switched network 190-1. The access manager 140 receives the requested first content (from the server resource) and forwards it to communication device 110-1 over communication link 128-1 for consumption.

User 108-2 can execute a browser, media player application, etc., on communication device 110-2. Assume that the user 108-2 transmits a request to access manager 140 for retrieval of second content. The access manager 140 keeps track of the network address of communication device 110-2. On behalf of the communication device 110-2, the access manager 140 transmits the request for second content upstream over shared communication link 191 to an appropriate server in packet-switched network 190-1. The access manager 140 receives the requested second content and forwards it to communication device 110-2 for consumption. As further discussed herein, the access manager 140 can limit upstream and/or downstream flows of data in accordance with access profile information.

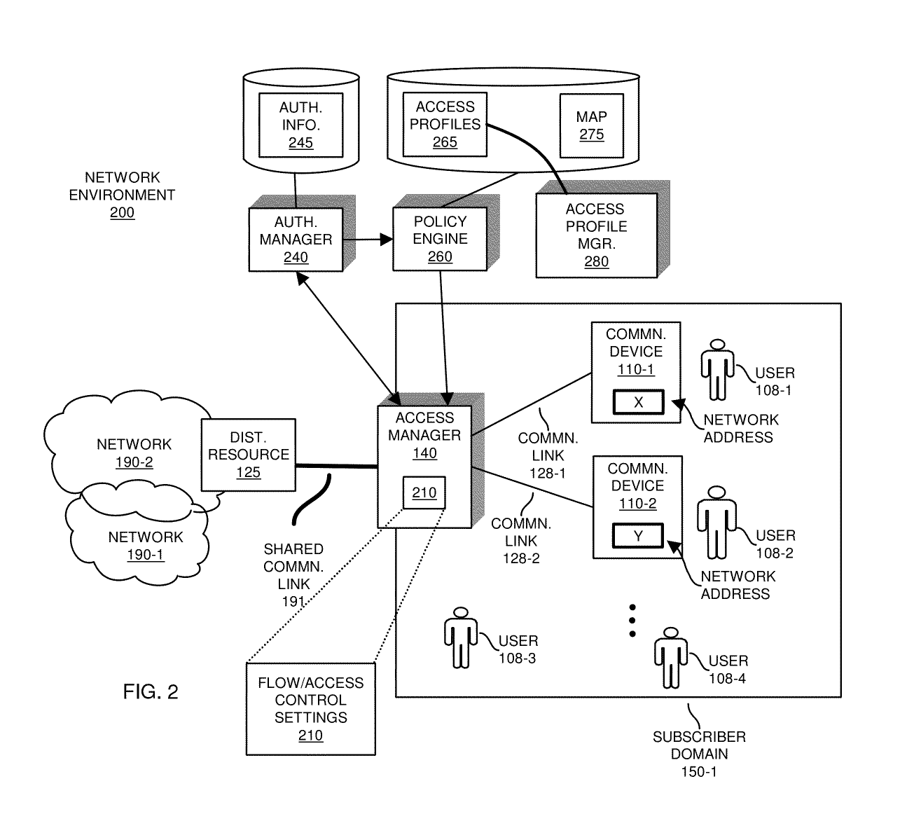

FIG. 2 is an example diagram illustrating access management on a per-user basis according to embodiments herein

In this example embodiment, network environment 200 includes access profile manager 280. Access profile manager 280 can reside at any suitable location and can be implemented in any suitable manner to enable a respective user in subscriber domain 150-1 to create and store user access profiles 265 for subsequent use.

For example, access profile manager 280 can be a web site accessed by a respective user, access profile manager 280 can be software executing on a respective computer device operated by a user, etc. Via creation of access profiles 265, the user such as an administrator in subscriber domain 150-1 is able to control network access by different users.

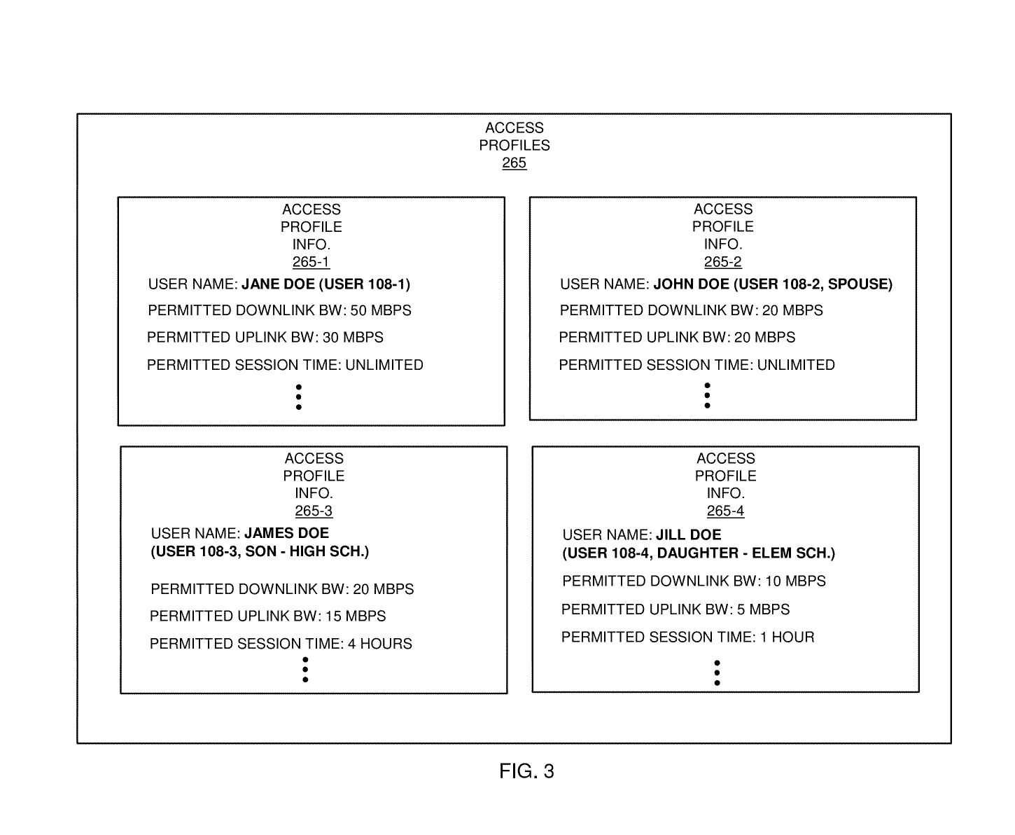

In this example embodiment, assume that a subscriber (such as an administrator) in subscriber domain 150-1 creates access profiles 265 as shown in FIG. 3. Based on input received from the administrator (such as Jane Doe) in subscriber domain 150-1: the access profile manager 280 stores corresponding settings associated with the user 108-1 (such as Jane Doe) in access profile information 265-1; the access profile manager 280 stores corresponding settings associated with the user 108-2 (such as John Doe) in access profile information 265-2; the access profile manager 280 stores corresponding settings associated with the user 108-3 (such as James Doe) in access profile information 265-3; the access profile manager 280 stores corresponding settings associated with the user 108-4 (such as Jill Doe) in access profile information 265-4; and so on. Accordingly, an administrator in the subscriber domain 150-1 can create a respective access profile for each possible user in subscriber domain 150-1.

If desired, the access profiles 265 can be modified. For example, subsequent to creation of access profiles 265, the administrator in subscriber domain 150-1 can utilize access profile manager 280 at a subsequent time to modify settings associated with the access profiles 265.

In this example embodiment, the corresponding access profile information indicates the different network access settings assigned to each user. For example, as indicated by access profile information 265-1, user 108-1 such as Jane Doe (the administrator) is permitted up to 50 megabits per second of downlink bandwidth to receive data from access manager 140. User 108-1 is permitted 30 megabits per second of uplink bandwidth to transmit data from a communication device to and through access manager 140. In this instance, there is no limit as to how long the user 108-1 can use a respective communication device to access remote networks via communications through access manager 140 and shared communication link 191.

As indicated by access profile information 265-2, user 108-2 such as John Doe (a spouse of administrator) is permitted up to 20 megabits per second of downlink bandwidth and 20 megabits per second of uplink bandwidth. There is no limit as to how long the user 108-2 can use a respective communication device to access remote networks via communications through access manager 140 and shared communication link 191.

As indicated by access profile information 265-3, user 108-3 such as James Doe (a son of administrator) is permitted up to 20 megabits per second of downlink bandwidth and 15 megabits per second of uplink bandwidth. In this instance, there is a limit of 4 hours per day that the user 108-3 can use a respective communication device to access network 190-3 via communications through access manager 140. User may be a high school student.

As indicated by access profile information 265-4, user 108-4 such as Jill Doe (a daughter of administrator and elementary school student) is permitted up to 10 megabits per second of downlink bandwidth and 5 megabits per second of uplink bandwidth. There is a limit of 1 hour per day that the user 108-4 can use a respective communication device to access remote networks via communications through access manager 140 and shared communication link 191.

Referring again to FIG. 2, subsequent to creation of access profiles 265, assume that the user 108-1 operates communication device 110-1 and would like to retrieve content available from packet-switched network 190-1 and/or core network 190-2 through access manager 140. Assume that the user 108-2 operates communication device 110-2 and would like to retrieve content available from packet-switched network 190-1 and/or core network 190-2 through access manager 140.

In such an instance, upon first use of communication device 110-1, the communication device 110-1 creates an association with access manager 140. In one embodiment, prior to use of access manager 140 for retrieval of content, the user 108-1 is authenticated. For example, user 108-1 provides authentication information such as a password, username, etc., through access manager 140 to authentication manager 240. Authentication manager 240 accesses authentication information 245 to determine whether user 108-1 operating communication device 110-1 should be allowed network access through access manager 140.

Assume that the authentication manager 240 indicates that the user 108-1 provides the appropriate username and password and has been properly authenticated. In such an instance, the authentication manager 240 (or other suitable resource) communicates an identity of the authenticated user 108-1 to policy engine 260. Policy engine 260 uses map 275 to identify and obtain an appropriate access profile associated with user 108-1.

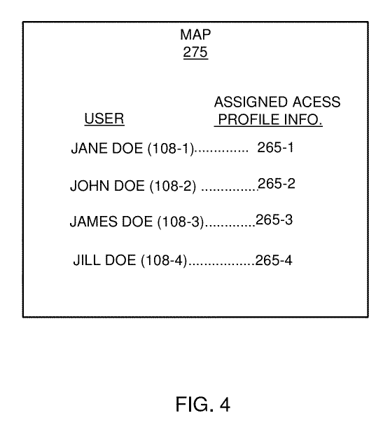

As an example, FIG. 4 illustrates a mapping of users to corresponding access profiles 265. In this instance, via map 275, the policy engine 260 identifies that user 108-1 is assigned access profile information 265-1; the policy engine 260 identifies that user 108-2 is assigned access profile information 265-2; the policy engine 260 identifies that user 108-3 is assigned access profile information 265-3; the policy engine 260 identifies that user 108-4 is assigned access profile information 265-4; and so on.

Referring again to FIG. 2, the policy engine 260 obtains the access profile information 265-1 assigned to users 108-1 and initiates forwarding of the access profile information 265-1 to access manager 140. Access manager 140 uses the access profile information 265-1 to configure corresponding flow/access control settings 210.

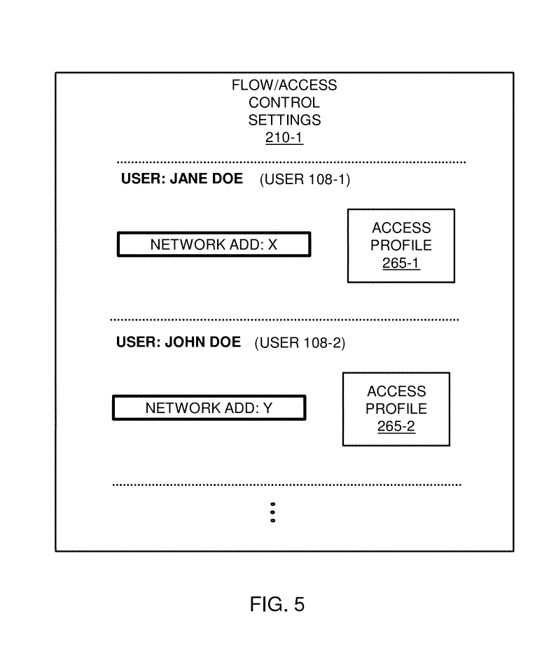

An instance of flow/access control settings 210-1 used by access manager 140 is shown in FIG. 5. In addition to receiving the access profile information 265-1, the access manager 140 receives a corresponding network address X assigned to the communication device 110-1 operated by the user 108-1. In one embodiment, the access manager 140 receives the network address X during initial association and establishment of respective communication link 128-1 (FIG. 2), although the network address can be received at any suitable time.

Access manager 140 associates the access profile information 265-1 received from the policy engine 260 to the communication device 110-1 having network address X. More specifically, as shown in flow/access control settings 210-1 in FIG. 5, the access manager 140 associates the access profile information 265-1 to network address X. Based on the access profile information 265-1, the access manager 140 controls data traffic flows (such as data packets having a network X) to and from the communication device 110-1 (assigned network address X) in a manner as specified by the corresponding access profile information 265-1 assigned to the user 108-1.

For example, in accordance with access profile information 265-1 assigned to user 108-1 operating the communication device 110-1: the communication device 110-1 can receive data in a downlink direction on communication link 128-1 at a rate of up to 50 megabits per second; the communication device 110-1 is able to transmit in the uplink from communication device 110-1 to access manager 140 at a data rate of up to 30 megabits per second; there is no time limit as to how long the user 108-1 operating communication device 110-1 can use the communication link 128-1.

Further in this example, user 108-2 operates communication device 110-2. Subsequent to authentication of the user 108-2 via authentication manager 240 in a similar manner as previously discussed, the policy engine 260 (or other suitable resource) uses map 275 to identify respective access profile information 265-2 assigned to user 108-2. The access manager 140 receives the access profile information 265-2 from policy engine 260.

Access manager 140 associates the access profile information 265-2 received from the policy engine 260 to the communication device 110-2 having assigned network address Y. More specifically, as shown in flow/access control settings 210-1 in FIG. 5, the access manager 140 associates the access profile information 265-2 to communication device 110-2 having assigned network address X.

Based on the access profile information 265-2, the access manager 140 controls data traffic flows to and from the communication device 110-2 (network address Y) over communication link 128-2 in a manner as specified by the corresponding access profile information 265-2. For example, in accordance with access profile information 265-2 assigned to user 108-2 operating the communication device 110-2: the communication device 110-2 can receive data in a downlink direction on communication link 128-2 at a rate of up to 20 megabits per second; the communication device 110-2 is able to transmit in the uplink from communication device 110-2 to access manager 140 at a data rate of up to 20 megabits per second; there is no time limit as to how long the user 108-2 operating communication device 110-2 can use the communication link 128-2.

Accordingly, embodiments herein include receiving access profile information associated with users in a subscriber domain of a cable network environment. Subsequent to verifying the authentication information of each user, and in accordance with received access profile information associated with respective users, the access manager 140 provides each of the communication devices 110 access to one or more remote networks 190-1, 190-2 through access manager 140 and shared communication link 191.

Assume that the user 108-1 ends her communication session and logs off of communication device 110-1. Assume further that the user 108-4 logs on to communication device 110-1 and provides appropriate authentication information to authentication manager 240. Subsequent to authentication of the user 108-4 via authentication manager 240, the policy engine 260 (or other suitable resource) uses map 275 to identify the access profile information 265-4 assigned to user 108-4. The access manager 140 receives the access profile information 265-4 from policy engine 260.

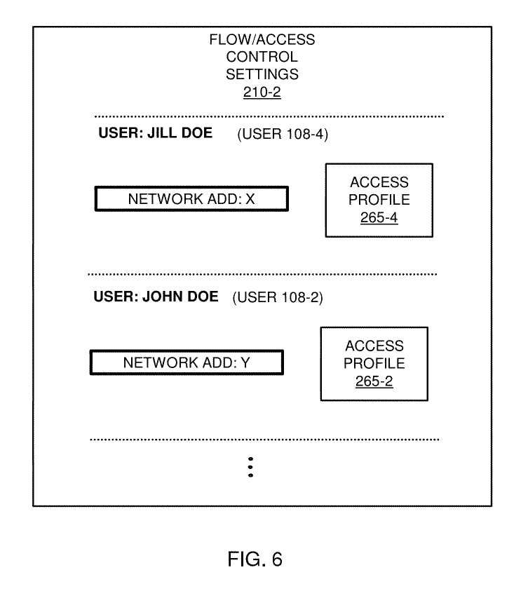

Access manager 140 associates the access profile information 265-4 received from the policy engine 260 to the communication device 110-1 having assigned network address X (now used by user 108-4). In this instance, as shown in flow/access control settings 210-2 in FIG. 6, the access manager 140 updates the flow/access control settings 210-2 and associates the access profile information 265-4 to communication device 110-1 having assigned network address X.

Based on the access profile information 265-4 (associated with the user 108-4 now operating the communication device 110-1), the access manager 140 controls data traffic flows to and from the communication device 110-1 (network address X) in a manner as specified by the corresponding access profile information 265-4. For example, in accordance with access profile information 265-4 assigned to user 108-4 operating the communication device 110-1: the communication device 110-1 can receive data in a downlink direction on communication link 128-1 at a rate of up to 10 megabits per second; the communication device 110-1 is able to transmit in the uplink on communication link 128-1 from communication device 110-1 to access manager 140 at a data rate of up to 5 megabits per second; there is a limit as to how long the user 108-4 operating communication device 110-4 can use the communication link 128-1.

In one embodiment, the access manager 140 includes one or more timers that keep track of how long each user uses the different available network services. In this example, the access manager 140 includes a timer that tracks how long the user 108-4 has access to networks 190-1 and 190-2 via communications over communication link 128-1 to access manager 140. The time can be tracked for an entire day. The timers can be reset each day, week, etc. In accordance with the access profile information 265-4, if the tracked amount of time in which user 108-4 uses the communication link 128-1 exceeds a threshold value of 1 hour, the access manager 140 discontinues allowing the user 108-4 access to networks 190-1 and 190-2 through access manager 140. Accordingly, a user can be limited as to how long they are able to connect to access manager 140 and retrieve content.

In accordance with yet further embodiments, the access profile information 265-4 can indicate a pre-condition that must be met in order for the user 108-4 to be provided access through access manager 140. As an example, a pre-condition assigned to user 108-4 may be that the user 108-4 complete her homework before being allowed to use the communication device 110-1 to access the Internet through the access manager 140. Accordingly, the access manager 140 may deny the user 108-4 use of the access manager 140 to access the Internet until the pre-condition has been met.

In one embodiment, the access manager 140 analyzes the corresponding profile information 265-4 to identify the pre-condition that must be met before user 108-4 is allowed to use access manager 140 to access the Internet. The access manager 140 can learn that the pre-condition has been met in any suitable manner. For example, in one non-limiting example embodiment, based on monitoring use of the communication device 110-1 by the user 108-4, the access manager 140 can detect occurrence of a trigger event indicating that the pre-condition has been fulfilled. In response to detecting fulfillment of the pre-condition as specified by the corresponding access profile information 265-4, the access manager 140 provides the communication device 110-1 (as operated by user 108-4) access to the remote networks for the amount of time as specified by the time limit information (e.g., 1 hour).

As previously discussed, the access profile information assigned to a respective user can specify a maximum rate at which a respective user is able to transmit data in the upstream (uplink) from a communication device to the access manager 140 over a corresponding communication link. One way of controlling a flow of data in the upstream direction from a respective communication device through the access manager 140 and the shared communication link 191 is to retrieve an uplink bandwidth value from a corresponding access profile information assigned to a user. In this latest example, the access manager 140 can be configured to retrieve an uplink bandwidth value of 5 megabits per second from access profile information 265-4. The uplink bandwidth value specifies an assigned limit of transmitting data upstream from the user 108-4 operating a respective communication device 110-1 over communication link 128-1 to access manager 140. In one embodiment, the access manager 140 communicates the uplink bandwidth value (5 megabits per second) to the communication device operated by the user 108-4.

In accordance with the received uplink bandwidth value of 5 megabits per second, the communication device 110-1 can be configured to limit upstream transmission of data to the access manager 140 and shared communication link 191 to the remote networks 190-1 and 190-2.

In a similar manner, each of the communication devices can be configured to limit uplink communications by an amount as specified by the corresponding access profile information of a user operating the communication device.

As previously discussed, access profile information assigned to a respective user can specify a maximum rate at which a respective user is able to receive data in the downstream (downlink) from the access manager 140. One way of controlling a flow of data in the downstream direction from the access manager 140 is to retrieve a downlink bandwidth value from corresponding access profile information assigned to a user. For example, in this latest example, the access manager 140 can be configured to retrieve a downlink bandwidth value of 10 megabits per second from access profile information 265-4. The downlink bandwidth value specifies an assigned limit of transmitting data downstream from the access manager 140 to the communication device 110-1 operated by user 108-4. Assume that the access manager 140 receives data directed to communication device 110-1 operated by user 108-4. In accordance with the downlink bandwidth limitation of 10 megabits per second, the access manager 140 limits a rate of transmitting data downstream over communication link 128-1 to under 10 megabits per second.

The access manager 140 can be configured to control rates of transmitting the data downstream to each of multiple users in a similar manner.

Accordingly, the access manager 140 such as a wireless access point can receive data from the remote networks 190-1 and 190-2 over a shared communication link 191 in a cable network environment. The access manager 140 controls transmission of the received data over wireless bandwidth to the communication devices in a manner as specified by the corresponding access profile information assigned to the users. For example, the access manager 140 limits transmission of downstream data to a communication device operated by user 108-1 to 50 megabits per second; the access manager 140 limits transmission of downstream data to a communication device operated by user 108-2 to 30 megabits per second; the access manager 140 limits transmission of downstream data to a communication device operated by user 108-3 to 20 megabits per second; the access manager 140 limits transmission of downstream data to a communication device operated by user 108-1 to 10 megabits per second; and so on.

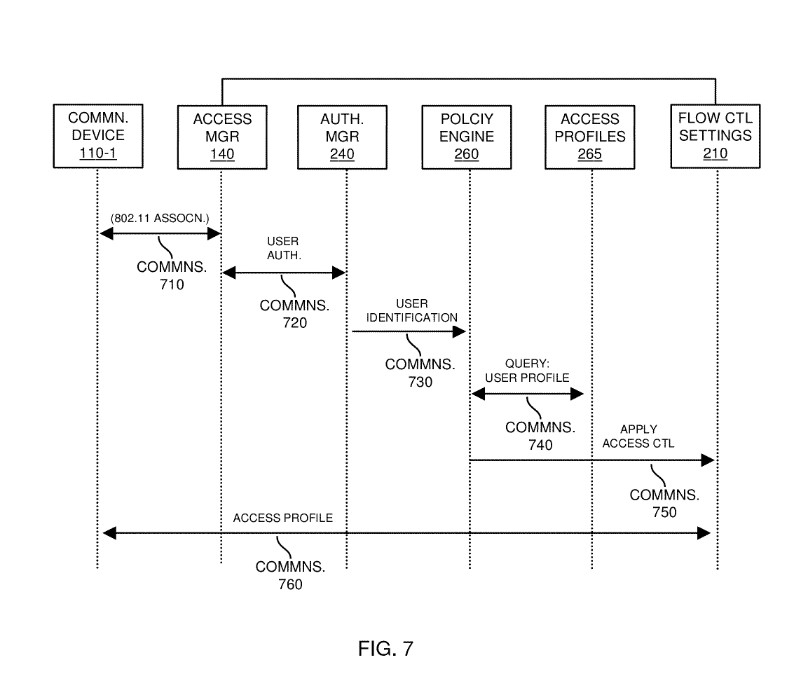

FIG. 7 is an example diagram illustrating communications facilitating access management using one or more access profiles according to embodiments herein. Note that the following discussion regarding flow of communications may overlap with the operations as discussed above.

In one embodiment, initially, via communications 710, the communication device 110-1 creates an association with access manager 140 to establish communication link 128-1.

Prior to allowing the communication device 110-1 access to a remote network through access manager 140, via communications 720, the authentication manager 240 authenticates the user 108-1.

Subsequent to proper authentication, via communications 730, the authentication manager 240 notifies the policy engine 260 of the identity of the user 108-1 operating communication device 110-1.

Via communications 740, the policy engine 260 retrieves the appropriate access profile information 265-1 from multiple access profiles 265. The access profile information 265-1 is assigned to user 108-1.

Via communications 750, the access manager 140 receives the access profile information 265-1 and configures flow/access control settings 210.

Thereafter, via conveyance of communications 760, the access manager 140 provides the communication device 110-1 operated by the user 108-1 access 760 to shared communication link 191 and networks 190-1 and 190-2 in accordance with the access profile information 265-1.

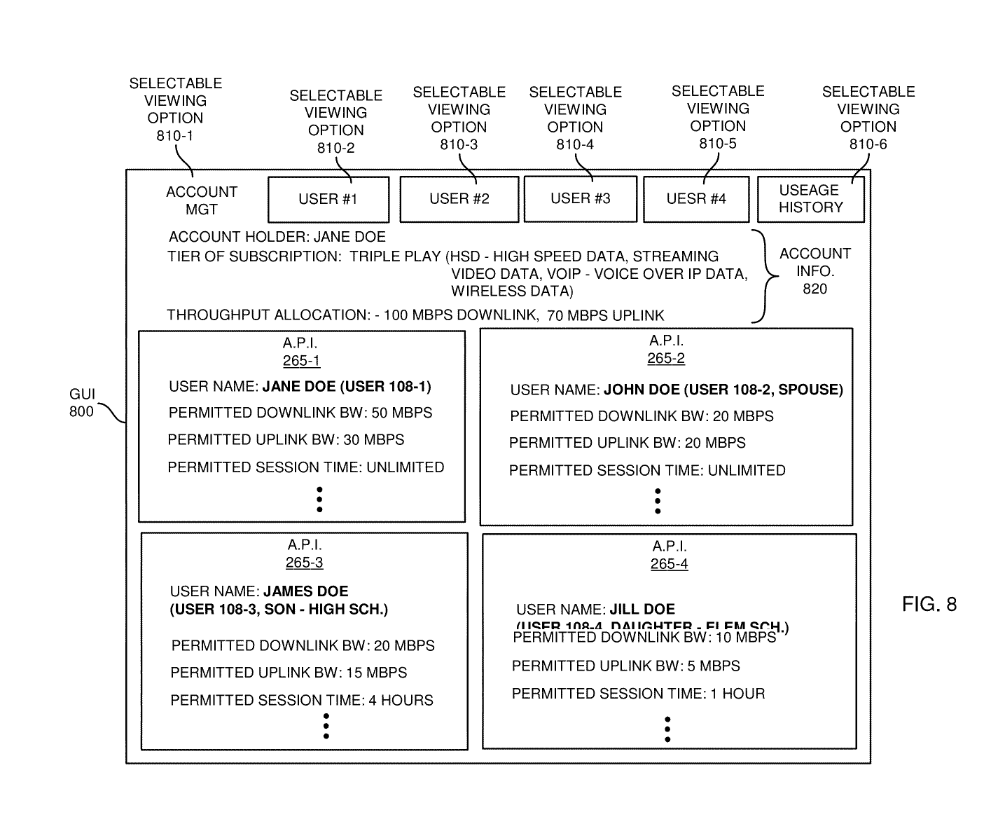

FIG. 8 is an example diagram illustrating a user interface to manage access profile information according to embodiments herein.

As mentioned, network environment 200 (in FIG. 2) can include access profile manager 280 enabling a subscriber to manage their respective account. For example, via the access profile manager 280, a subscriber is able to create and modify access profile information for each of multiple users; view account information, etc.

In this example embodiment, graphical user interface 800 represents display information produced by access profile manager 280 for display on a respective display screen operated by the subscriber Jane Doe.

As shown, graphical user interface 800 includes selectable viewing option 810-1, selectable viewing option 810-2, selectable viewing option 810-3, selectable viewing option 810-4, selectable viewing option 810-5, and selectable viewing option 810-6. By way of a non-limiting example, the selectable viewing options can be selectable tabs to view different types of information associated with the account.

In this non-limiting example embodiment, selection of the selectable viewing option 810-1 enables the user 108-1 (administrator) to view account information 820 (such as type of subscriber service, amount of available bandwidth on shared communication link, etc.) as well as access profiles 265 for each of multiple users in subscriber domain 150-1.

Selection of the selectable viewing option 810-2 enables the user to view access profile information 265-1 and corresponding usage information associated with user 108-1.

Selection of the selectable viewing option 810-3 enables the user to view access profile information 265-2 and corresponding usage information associated with user 108-2.

Selection of the selectable viewing option 810-4 enables the user to view access profile information 265-3 and corresponding usage information associated with user 108-3.

Selection of the selectable viewing option 810-5 enables the user to view access profile information 265-4 and corresponding usage information associated with user 108-4.

Selection of the selectable viewing option 810-6 enables the user to view usage information associated with each of multiple users 108.

In this non-limiting example embodiment, assume that the subscriber (such as an administrator of a respective account) selects selectable viewing option 810-1. In response to receiving selection of selectable viewing option 810-1, the access profile manager 280 initiates display of account information 820 and corresponding access profile information 265 for viewing by the subscriber.

As indicated by account information 820, the throughput allocation of 100 megabits per second on the downlink and 70 megabits per second on the uplink indicates the amount of bandwidth in shared communication link 191 allocated for use by collective members in subscriber domain 150-1. More specifically, shared communication link 191 supports up to 100 megabits per second of data from remote networks to subscriber domain 150-1; shared communication link 191 supports up to 70 megabits per second of data from subscriber domain 150-1 to remote networks.

In one embodiment, the 100/70 values represent a guaranteed amount of bandwidth that a service provider will provide to subscriber domain 150-1 via shared communication link 191.

As previously discussed, the available uplink and downlink bandwidth (100 Downlink/70 uplink) available on shared communication link 191 can be split amongst multiple users 108. For example, as indicated by access profile information 265-1, a downlink bandwidth of 50 megabits per second of the total downlink bandwidth of 100 megabits per second is allocated for use by user 108-1; as indicated by access profile information 265-2, a downlink bandwidth of 20 megabits per second of the total downlink bandwidth of 100 megabits per second is allocated for use by user 108-2; as indicated by access profile information 265-3, a downlink bandwidth of 20 megabits per second of the total uplink bandwidth of 100 megabits per second is allocated for use by user 108-3; as indicated by access profile information 265-4, a downlink bandwidth of 10 megabits per second of the total downlink bandwidth of 100 megabits per second is allocated for use by user 108-4.

Additionally, as indicated by access profile information 265-1, an uplink bandwidth of 30 megabits per second of the total uplink bandwidth of 70 megabits per second is allocated for use by user 108-1; as indicated by access profile information 265-2, an uplink bandwidth of 20 megabits per second of the total uplink bandwidth of 70 megabits per second is allocated for use by user 108-2; as indicated by access profile information 265-3, an uplink bandwidth of 15 megabits per second of the total uplink bandwidth of 70 megabits per second is allocated for use by user 108-3; as indicated by access profile information 265-4, an uplink bandwidth of 5 megabits per second of the total uplink bandwidth of 70 megabits per second is allocated for use by user 108-4.

Thus, in one embodiment, a service provider associated with shared communication link 191 can provide limited upstream bandwidth (such as 70 megabits per second) in shared communication link 191 to communicate from the access manager 140 to one or more destinations in network 190-1, 190-2, . . . . As previously discussed, via access profiles 265, the access manager 140 controls flows and apportions use of the limited upstream bandwidth in the shared communication link 191 amongst the communication devices in accordance with the access profiles 265 assigned to the users 108.

Controlling an upstream flow of data from users 108 (operating communication devices 110) to access manager 140 prevents a bottlenecks as the access manager 140 can theoretically transmit the received upstream traffic from the communication devices 110 as fast as the data is received.

In certain instances, the shared communication link 191 can experience congestion. In such an instance, in response to detecting occurrence of congestion on the shared communication link 191, the access manager 140 adjusts a limit of wireless bandwidth allocated for use by the multiple communication devices 110.

As an example, assume that each of the users 108-1, 108-2, 108-3, and 108-4 operates a respective communication device in subscriber domain 150-1. Each of the communication devices is able to communicate in accordance with the assigned upstream and downstream bandwidth limitations as previously discussed. Assume that the available downlink bandwidth drops from 100 to 50 megabits per second. In such an instance, in response to detecting this condition, the access manager 140 can be configured to proportionally adjust the amount of downlink bandwidth assigned to the users 108. For example, in one embodiment, in response to the congestion and reduction of available downlink bandwidth by 25%, the access manager 140 can reduce the downlink bandwidth limits assigned to each of the users by 25%. In such an instance, a communication link from the access manager 140 to the communication device operated by user 108-1 would be allocated a maximum downlink bandwidth of 37.5 megabits per second; a communication link from access manager to a communication device operated by user 108-2 would be allocated a maximum downlink bandwidth of 15 megabits per second; a communication link from access manager 140 to a communication device operated by user 108-3 would be allocated a maximum downlink bandwidth of 15 megabits per second; and a communication link from access manager 140 to a communication device operated by user 108-4 would be allocated a maximum downlink bandwidth of 7.5 megabits per second. Accordingly, one solution to handling congestion is to proportionally adjustment downlink bandwidth limitations for each user when experiencing congestion in the shared communication link 191.

As another example, assume again that each of the users 108-1, 108-2, 108-3, and 108-4 operates a respective communication device in subscriber domain 150-1. Each of the communication devices is able to communicate in accordance with the assigned upstream and downstream bandwidth limitations. Assume that the available uplink bandwidth drops by 50% from 70 to 35 megabits per second. In such an instance, in response to detecting this condition, the access manager 140 can be configured to proportionally adjust the amount of uplink bandwidth assigned to the users 108. For example, in response to the congestion and reduction of available uplink bandwidth by 50%, the access manager 140 reduces the downlink bandwidth limits for each of the users by 50%. In such an instance, a communication device operated by user 108-1 would be allocated a maximum uplink bandwidth of 15 megabits per second over a respective communication link to access manager 140; a communication device operated by user 108-2 would be allocated a maximum uplink bandwidth of 10 megabits per second over a respective communication link to access manager 140; a communication device operated by user 108-3 would be allocated a maximum uplink bandwidth of 7.5 megabits per second over a respective communication link to access manager 140; and a communication device operated by user 108-4 would be allocated a maximum uplink bandwidth of 2.5 megabits per second over a respective communication link to access manager 140. Accordingly, one solution to handling congestion is to proportionally adjust uplink bandwidth limitations for each user when experiencing congestion.

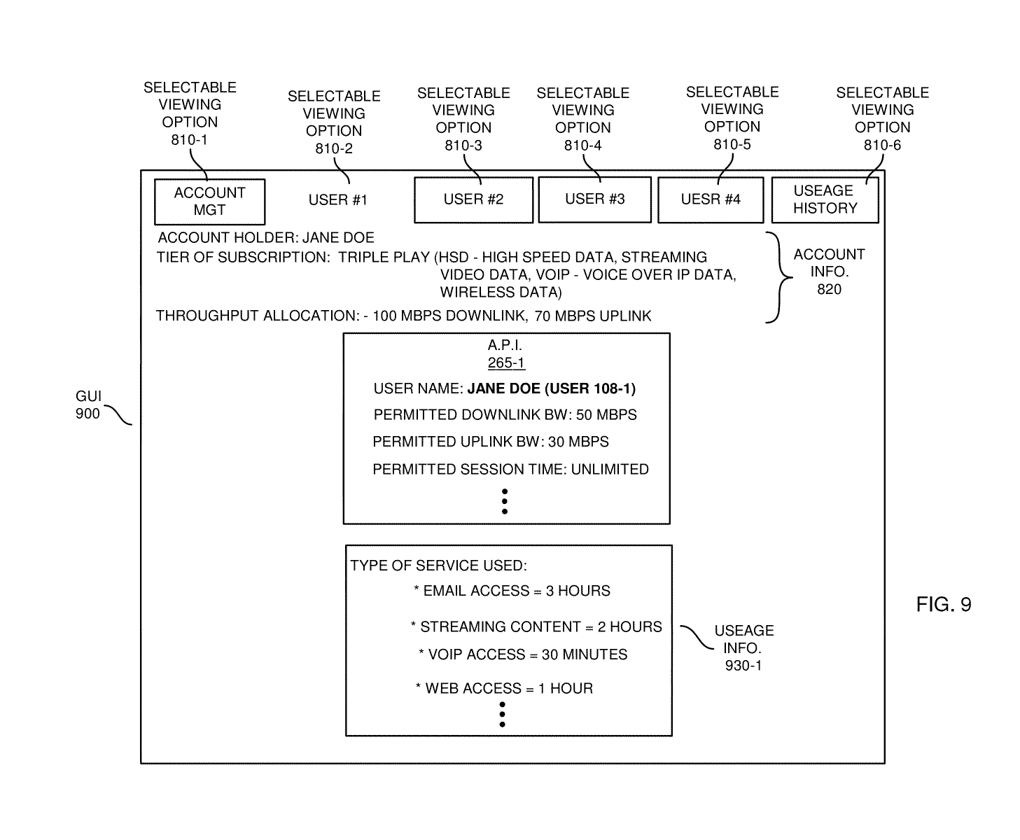

FIG. 9 is an example diagram illustrating a user interface to view access settings and network usage information according to embodiments herein.

In this example, in response to selection of selectable viewing option 810-2, the access profile manager 280 produces graphical user interface 900 as shown in FIG. 9. Selectable viewing option 810-2 corresponds to user #1 (user 108-1). Graphical user interface 900 displays: account information 820, access profile information 265-1 assigned to user 108-1, and usage information 930-1.

Usage information 930-1 indicates information such as the amount of time that the corresponding user (user 108-1 in this example) used the available uplink and downlink services for a given timeframe such as a day, week, etc.

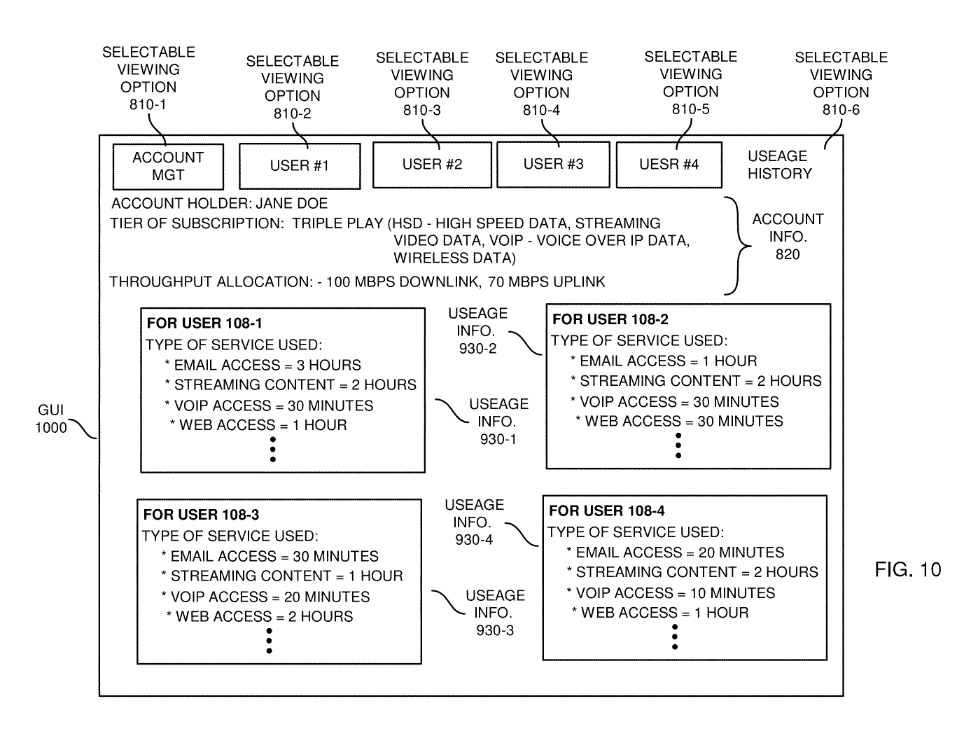

FIG. 10 is an example diagram illustrating a user interface to view network usage amongst multiple users according to embodiments herein.

In this example, in response to selection of selectable viewing option 810-6, the access profile manager 280 produces graphical user interface 1000 as shown in FIG. 10 for viewing by subscriber Jane Doe. In this instance, graphical user interface 1000 displays: account information 820 as well as usage information 930-1 (for user 108-1), usage information 930-2 (for user 108-2), usage information 930-3 (for user 108-3), and usage information 930-4 (for user 108-4).

As previously discussed, usage information 930-1 indicates information such as the amount of time that the corresponding user (user 108-1 in this example) used the available corresponding uplink and downlink services for a given timeframe such as a day, week, etc.

Usage information 930-2 indicates information such as the amount of time that the corresponding user (user 108-2 in this example) used the available corresponding uplink and downlink services for a given timeframe such as a day, week, etc.

Usage information 930-3 indicates information such as the amount of time that the corresponding user (user 108-3 in this example) used the available corresponding uplink and downlink services for a given timeframe such as a day, week, etc.

Usage information 930-4 indicates information such as the amount of time that the corresponding user (user 108-4 in this example) used the available corresponding uplink and downlink services for a given timeframe such as a day, week, etc.

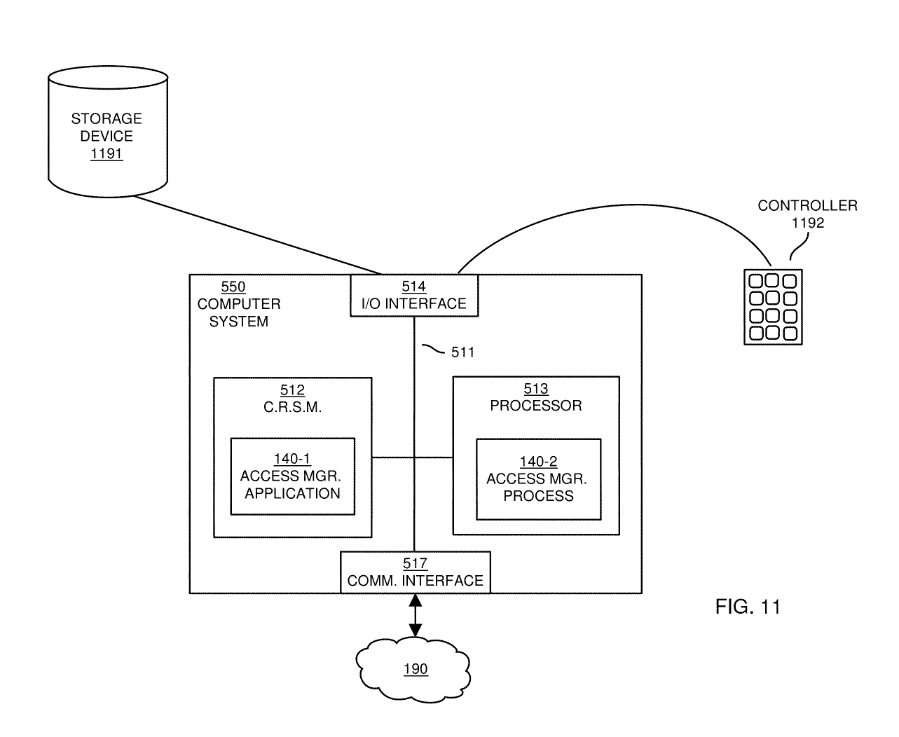

FIG. 11 is a diagram illustrating an example computer architecture in which to execute any of the functionality according to embodiments herein. Any of the different processing techniques can be implemented via execution of software code on a computer system.

For example, as shown, computer system 550 (e.g., computer processor hardware) of the present example can include an interconnect 511 that couples computer readable storage media 512 such as a non-transitory type of media (i.e., any type of hardware storage medium) in which digital information can be stored and retrieved. The computer system 550 can further include processor resource 513 (i.e., computer processor hardware such as one or more processor co-located or disparately located processor devices), I/O interface 514, communications interface 517, etc.

Computer processor hardware (i.e., processor 513) can be located in a single location (such as in access manager 140) or can be distributed amongst multiple locations.

As its name suggests, I/O interface 514 provides connectivity to external resources such as storage devices (such as storage device 1191), control devices (such as controller 1192), one or more display screens, etc.

Computer readable storage medium 512 can be any hardware storage device to store data such as memory, optical storage, hard drive, floppy disk, etc. In one embodiment, the computer readable storage medium 512 stores instructions and/or data.

Communications interface 517 enables the computer system 550 and processor resource 513 to communicate over a resource such as any of networks 190. I/O interface 514 enables processor resource 513 to access data from a local or remote location, control a respective display screen, receive input, etc.

As shown, computer readable storage media 512 can be encoded with access manager application 140-1 (e.g., software, firmware, etc.) executed by processor resource 513. Access manager application 140-1 can be configured to include instructions to implement any of the operations as discussed herein.

During operation of one embodiment, processor resource 513 accesses computer readable storage media 512 via the use of interconnect 511 in order to launch, run, execute, interpret or otherwise perform the instructions in access manager application 140-1 stored on computer readable storage medium 512.

Execution of the access manager application 140-1 produces processing functionality such as access manager process 140-2 in processor resource 513. In other words, the access manager process 140-2 associated with processor resource 513 represents one or more aspects of executing access manager application 140-1 within or upon the processor resource 513 in the computer system 550.

Those skilled in the art will understand that the computer system 550 can include other processes and/or software and hardware components, such as an operating system that controls allocation and use of hardware resources to execute access manager application 140-1.

In accordance with different embodiments, note that computer system may be any of various types of devices, including, but not limited to, a set-top box, access point, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, etc., or in general any type of computing or electronic device.

The computer system 550 may reside at any location or multiple locations in network environment 100. The computer system 550 can be included in any suitable resource in network environment 100 to implement functionality as discussed herein.

Note that each of the other functions as discussed herein can be executed in a respective computer system based on execution of corresponding instructions.

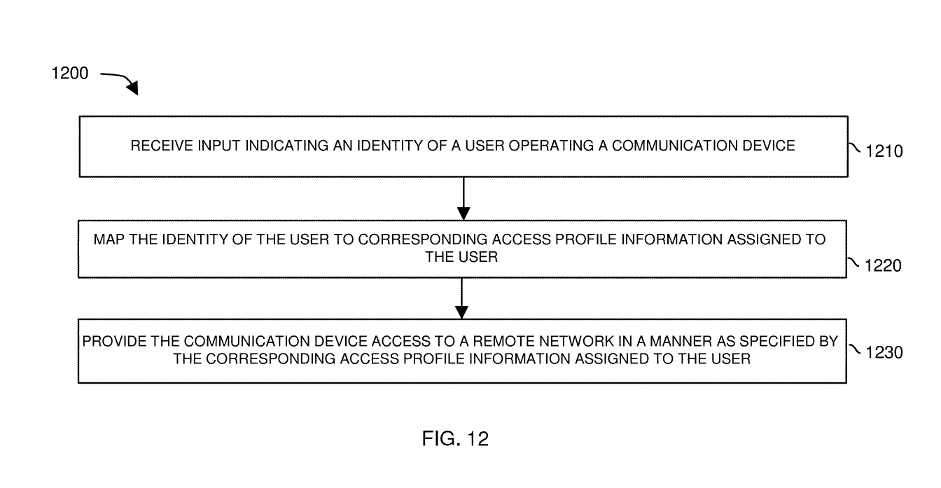

FIG. 12 is a flowchart 1200 illustrating an example method according to embodiments. Note that there will be some overlap with respect to concepts as discussed above. The processing in the flowcharts below can be executed in any suitable order.

In processing block 1210, the access manager 140 receives input indicating an identity of a user 108-1 operating a communication device 110-1.

In processing block 1220, the access manager 140 initiates mapping of the identity of the user 108-1 to corresponding access profile information 265-1 assigned to the user 108-1.

In processing block 1230, the access manager 140 provides the communication device 110-1 access to one or more remote networks in a manner as specified by the corresponding access profile information 265-1 assigned to the user 108-1.

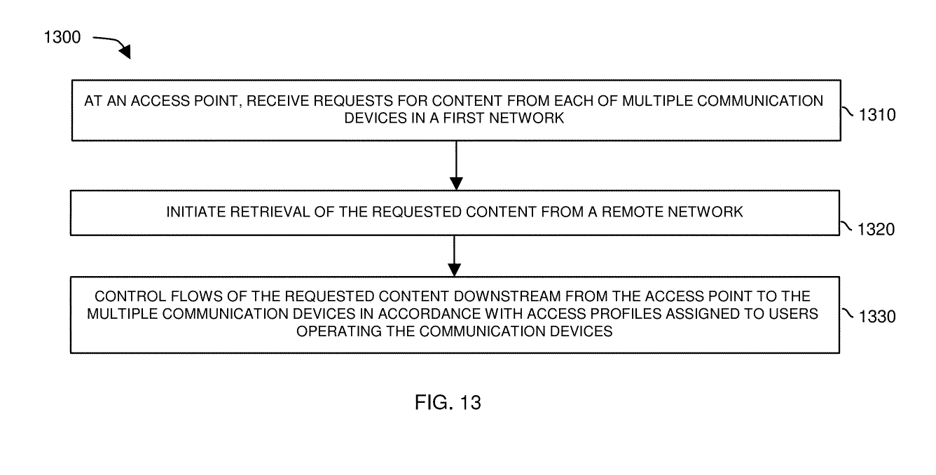

FIG. 13 is a flowchart 1300 illustrating an example method according to embodiments. Note that there will be some overlap with respect to concepts as discussed above. The processing in the flowcharts below can be executed in any suitable order.

In processing block 1310, the access manager 140 receives requests for content from each of multiple communication devices 110 in a first network (such as subscriber domain 150-1).

In processing block 1320, the access manager 140 initiates retrieval of the requested content from a remote network.

In processing block 1330, the access manager 140 controls flows of the requested content downstream from the access manager 140 to the multiple communication devices 110 in accordance with access profiles 265 assigned to users 108 operating the communication devices 110.

Note again that techniques herein are well suited for enabling a subscriber to control network access amongst multiple users in a subscriber domain. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving input indicating an identity of a user operating a communication device;
mapping the identity of the user to corresponding access profile information assigned to the user; and
providing the communication device access to a remote network in a manner as specified by the corresponding access profile information assigned to the user.

2. The method as in claim 1, wherein mapping the identity to corresponding access profile information includes:
accessing a map, the map including multiple entries, each of the multiple entries mapping a respective user identity to respective access profile information;
identifying an entry amongst the multiple entries, the identified entry including the identity of the user as specified by the input; and
selecting the corresponding profile information associated with the identified entry.

3. The method as in claim 1 further comprising:
utilizing the corresponding access profile information to configure settings of a wireless access point in a subscriber domain of a cable network environment; and
controlling flows of data to and from the user according to the settings.

4. The method as in claim 1, wherein providing the user of the communication device access to the remote network includes:
retrieving a bandwidth value from the corresponding profile information; and
limiting a downstream bandwidth of conveying data from the remote network to the communication device as specified by the bandwidth value.

5. The method as in claim 4, wherein limiting the downstream bandwidth of conveying data to the communication device includes:
at a wireless access point in a cable network environment, allocating limited wireless bandwidth in a downstream direction from the wireless access point to the communication device.

6. The method as in claim 1 further comprising:
at the wireless access point, receiving data from the remote network over a shared communication link in a cable network environment; and
controlling transmission of the received data over wireless bandwidth to the communication device in a manner as specified by the corresponding access profile information assigned to the user.

7. The method as in claim 1 further comprising:
retrieving time limit information from the corresponding access profile information;
tracking access to the remote network by the user; and
limiting the communication device access to the remote network in accordance with an amount of time as specified by the time limit information.

8. The method as in claim 7 further comprising:
providing the communication device access to the remote network for the amount of time as specified by the time limit information in response to detecting fulfillment of a pre-condition as specified by the corresponding access profile information.

9. The method as in claim 8 further comprising:
analyzing the corresponding profile information to identify the pre-condition;
based on monitoring use of the communication device by the user, detecting occurrence of a trigger event indicating that the pre-condition has been fulfilled.

10. The method as in claim 1, wherein the input is first input;
wherein the user is a first user amongst multiple users in a subscriber domain of a cable network environment;
wherein the communication device is a first communication device;
wherein the corresponding access profile information is first access profile information;
the method further comprising:
receiving second input indicating an identity of a second user, the second user operating a second communication device in the subscriber domain;
mapping the identity of the second user to second access profile information, the second access profile information assigned to the second user; and
providing the second communication device access to the remote network as specified by the second access profile information.

11. The method as in claim 10 further comprising:
receiving settings associated with the first access profile information and the second access profile information from an administrator in the subscriber domain;
storing the settings associated with the first access profile information and the second access profile information in a repository; and
enabling the administrator access to modify the first access profile information and the second access profile information.

12. The method as in claim 1 further comprising:
receiving a network address assigned to the communication device;
associating the network address with the corresponding access profile information assigned to the user; and
wherein providing the communication device access to the remote network includes: controlling data traffic flows to and from the communication device in a manner as specified by the corresponding access profile information assigned to the user.

13. The method as in claim 1, wherein receiving input further includes receiving authentication information associated with the user, the user being one of multiple users in a subscriber domain of a cable network environment, the subscriber domain having limited available bandwidth over a shared communication link in the cable network environment, the method further comprising:
subsequent to verifying the authentication information, providing the communication device access to the remote network via use of the shared communication link.

14. The method as in claim 1 further comprising:
retrieving a bandwidth value from the corresponding access profile information assigned to the user, the bandwidth value specifying a limit of transmitting data upstream from the communication device to the remote network; and
communicating the bandwidth value to the communication device, the communication device limiting upstream transmission of data directed to the remote network in accordance with the bandwidth value.

15. A method comprising:
at an access point, receiving requests for content from each of multiple communication devices in a first network;
initiating retrieval of the requested content from a remote network; and
controlling flows of the requested content from the access point to the multiple communication devices in accordance with access profiles assigned to users operating the communication devices.

16. The method as in claim 15, wherein initiating retrieval of the requested content includes:
transmitting the requests for content upstream from the access point to a second network over a communication link shared amongst multiple subscriber domains; and
at the access point, receiving the requested content from the second network over the shared communication link.

17. The method as in claim 15, wherein multiple users operate the communication devices in a respective subscriber domain of a cable network environment including multiple subscriber domains, the method further comprising:
retrieving the access profiles assigned to the users; and
apportioning use of wireless bandwidth available in the subscriber domain to communicate between the access point and the multiple communication devices in accordance with the access profiles.

18. The method as in claim 17 further comprising:
in response to detecting occurrence of congestion on a shared communication link disposed between the access point and the remote network, adjusting a limit of wireless bandwidth allocated for use by the multiple communication devices.

19. The method as in claim 15 further comprising:
receiving input from a subscriber in a subscriber domain in which the multiple users reside; and
creating the access profiles in accordance with the input from the subscriber.

20. The method as in claim 15, wherein a service provider provides limited upstream bandwidth in a communication link to communicate from the access point through the communication link to the second network; and
wherein controlling the flows includes apportioning use of the limited upstream bandwidth in the communication link amongst the communication devices in accordance with the access profiles assigned to the users.

21. The method as in claim 15 further comprising:
creating the access profiles in accordance with input from an administrator in a subscriber domain in which the multiple communication devices reside;
storing the access profiles in a repository; and
enabling the administrator access to modify the access profiles.

22. A system comprising:
computer processor hardware; and
a hardware storage resource coupled to communicate with the computer processor hardware, the hardware storage resource storing instructions that, when executed by the computer processor hardware, causes the computer processor hardware to perform operations of:
receiving input indicating an identity of a user operating a communication device;
mapping the identity of the user to corresponding access profile information assigned to the user; and
providing the communication device access to a remote network in a manner as specified by the corresponding access profile information assigned to the user.

23. The computer system as in claim 22, wherein mapping the identity to corresponding access profile information includes:
accessing a map, the map including multiple entries, each of the multiple entries mapping a respective user identity to respective access profile information;
identifying an entry amongst the multiple entries, the identified entry including the identity of the user as specified by the input; and
selecting the corresponding profile information associated with the identified entry.

24. The computer system as in claim 22, wherein the computer processor hardware further performs operations of:
utilizing the corresponding access profile information to configure settings of a wireless access point in a subscriber domain of a cable network environment; and
controlling flows of data to and from the user according to the settings.

25. The computer system as in claim 22, wherein providing the user of the communication device access to the remote network includes:
retrieving a bandwidth value from the corresponding profile information; and
limiting a downstream bandwidth of conveying data from the remote network to the communication device as specified by the bandwidth value.

26. The computer system as in claim 25, wherein limiting the downstream bandwidth of conveying data to the communication device includes:
at a wireless access point in a cable network environment, allocating limited wireless bandwidth in a downstream direction from the wireless access point to the communication device.

27. The computer system as in claim 22, wherein the computer processor hardware further performs operations of:
at the wireless access point, receiving data from the remote network over a shared communication link in a cable network environment; and
controlling transmission of the received data over wireless bandwidth to the communication device in a manner as specified by the corresponding access profile information assigned to the user.

28. The computer system as in claim 22, wherein the computer processor hardware further performs operations of:
retrieving time limit information from the corresponding access profile information;
tracking access to the remote network by the user; and
limiting the communication device access to the remote network in accordance with an amount of time as specified by the time limit information.

29. The computer system as in claim 28, wherein the computer processor hardware further performs operations of:
providing the communication device access to the remote network for the amount of time as specified by the time limit information in response to detecting fulfillment of a pre-condition as specified by the corresponding access profile information.

30. The computer system as in claim 22, wherein the computer processor hardware further performs operations of:
analyzing the corresponding profile information to identify the pre-condition; and
based on monitoring use of the communication device by the user, detecting occurrence of a trigger event indicating that the pre-condition has been fulfilled.

31. The computer system as in claim 22, wherein the computer processor hardware further performs operations of:
receiving settings associated with the first access profile information and the second access profile information from an administrator in the subscriber domain;
storing the settings associated with the first access profile information and the second access profile information in a repository; and
enabling the administrator access to modify the first access profile information and the second access profile information.

32. The computer system as in claim 22, wherein the computer processor hardware further performs operations of:
receiving a network address assigned to the communication device;
associating the network address with the corresponding access profile information assigned to the user; and
wherein providing the communication device access to the remote network includes: controlling data traffic flows to and from the communication device in a manner as specified by the corresponding access profile information assigned to the user.

33. The computer system as in claim 22, wherein the computer processor hardware further performs operations of:
retrieving a bandwidth value from the corresponding access profile information assigned to the user, the bandwidth value specifying a limit of transmitting data upstream from the communication device to the remote network; and
communicating the bandwidth value to the communication device, the communication device limiting upstream transmission of data directed to the remote network in accordance with the bandwidth value.

34. Computer-readable hardware storage having instructions stored thereon, the instructions, when carried out by computer processor hardware, causing the computer processor hardware to perform operations of:
receiving requests for content from each of multiple communication devices in a first network;
initiating retrieval of the requested content from a remote network; and
controlling flows of the requested content from the access point to the multiple communication devices in accordance with access profiles assigned to users operating the communication devices.
